(19) United States
(12) Patent Application Publication
(10) Pub. No.: US 2006/0091300 A1
(43) Pub. Date: May 4, 2006

(54) Optical color sensor using diffractive elements

(76) Inventor: Ken A. Nishimura, Fremont, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/977,687

(22) Filed: Oct. 29, 2004

(51) Int. Cl. H01J 5/16

(52) U.S. Cl. 250/226

(57) ABSTRACT

Optical color sensor using diffractive elements. Semiconductor fabrication processes are used to form diffraction gratings as part of a photosensor. In a first embodiment, photosensors such as photodiodes are formed on a substrate, and diffraction gratings of fixed spacing are formed using the metallization layers common to semiconductor fabrication techniques. In a second embodiment, a linear photodiode array is formed on a substrate, and a diffraction grating with changing spacing is formed in the metal layers, providing a continuous color sensor. Other metal layers commonly used in semiconductor processing techniques may be used to provide apertures as needed.

### TECHNICAL FIELD

Embodiments in accordance with the invention relate generally to electrical means for sensing optical color of incident light.

### BACKGROUND

Sensing the spectral content of incident light is a common problem. A commonly used solution to this problem is to use a plurality of silicon photodiodes combined with a plurality of filters which selectively pass light of predetermined wavelengths.

This solution has a number of problems. The performance of such a sensor is limited by the accuracy of the light transmission characteristics of the filter. The selectivity of such a sensor is limited by the availability of filtering materials. The filter materials attenuate light, and different colored filters attenuate light differently, requiring additional calibration. The long-term stability of such a sensor is also dependent on the long-term stability of the sensor materials used.

### SUMMARY

In accordance with the invention, photodiodes or other light-sensitive elements are fabricated with diffraction gratings. A first embodiment uses a photosensor with an integrated single frequency grating. A second embodiment uses a linear photosensor array and an integrated diffraction grating covering a range of frequencies. The diffraction gratings are formed using metallization layers common to semiconductor fabrication. Additional metal layers may be used to form apertures as required.

### BRIEF DESCRIPTION OF THE DRAWINGS

The invention will best be understood by reference to the following detailed description of embodiments in accordance with the invention when read in conjunction with the accompanying drawings, wherein:

FIG. 1 shows a first optical sensor according to the invention,

FIG. 2 shows a first optical sensor with processing electronics, and

FIG. 3 shows a second optical sensor according to the invention.

### DETAILED DESCRIPTION

The invention relates to sensing the spectral content of incident light. The following description is presented to enable one skilled in the art to make and use the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments show but is to be accorded the widest scope consistent with the appended claims and with the principles and features described herein.

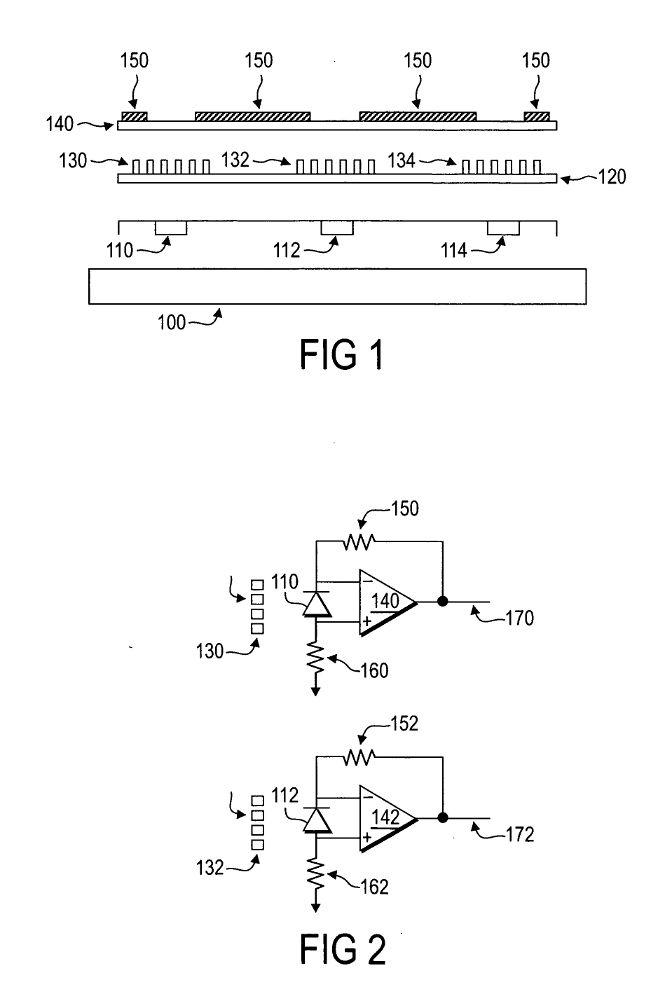

FIG. 1 shows a first sensor according to the present invention. Substrate 100 has photosensors 110, 112, 114 fabricated using fabrication techniques known to the semiconductor and integrated circuit arts such as photolithography. Note that there may be intervening layers between substrate 100 and photosensors 110, 112, 114. Photosensors 110, 112, 114 may be photodiodes, phototransistors, or other light-sensitive device, fabricated from semiconductor materials such as silicon, silicon-germanium, or like materials. Dielectric layer 120 also passes wavelengths of interest. Again, there may be additional layers between the layer 120 and the layer containing photosensors 110, 112, 114. Materials such as silicon dioxide (SᵢO₂), insulating materials, or other materials known to the art may be used for layer 120. Diffraction gratings 130, 132, 134 are formed on top of dielectric layer 120. Diffraction gratings 130, 132, 134 are formed of a material opaque to the wavelengths of interest, such as metal.

FIG. 1 shows a simplified representation of the present invention, with only key layers represented. Photosensors 110, 112, 114 may be fabricated at any layer in the semiconductor device. Diffraction gratings 130, 132, 134 are formed above the photosensors, with any number of intervening layers 120, as long as those intervening layers pass light in the wavelength range of interest.

The spatial distribution of light from a diffraction grating is controlled solely by the relationship of the wavelength of incident light compared with the physical dimensions of the grating. The grating, in conjunction with the spatial arrangement of the photodetector, directs light of desired wavelengths onto the photodetector. Note that the incident light reaching gratings 130, 132, 134 and photosensors 110, 112, 114 should be collimated. This collimation may be achieved through traditional optical means, such as slits, lenses, and the like. Because gratings 130, 132, 134 are manufactured with integrated circuit lithographic techniques, their optical properties are highly accurate and repeatable.

In an embodiment such as that shown in FIG. 1, gratings 130, 132, and 134 could be designed to pass red, green, and blue light respectively. Other embodiments of the invention could provide one photosensor—grating pair sensing a single wavelength range, two photosensor—grating pairs sensing a pair of wavelengths, such as red and blue, or more than three photosensor—grating pairs, as an example sensing red, blue, green, cyan, and magenta wavelengths. Single-wavelength sensors may be fabricated responsive to particular wavelengths of interest, such those produced by lasers.

An additional metal layer, or other opaque layer, may be used to provide an aperture. This aperture may be located between grating 130 and photosensor 120. The aperture 150 may be supported on an additional dielectric layer 140, between the grating and the light source. Such an aperture may act as a collimating element. Additionally, such an aperture may be used to insure that only certain areas of the device are illuminated, or to compensate for the difference in response of the photosensors at different wavelengths.

Additionally, gratings may be formed on more than one layer of metallization separated by intervening dielectric layers to further define the relationship between spatial distribution of the incident light and the wavelength. Moreover, the grating need not be active solely in one-dimension. For example, a two-dimensional spatial distribution as a function of wavelength is achievable using grating elements with active components which are substantially orthogonal to each other.

As standard integrated circuit techniques are used, additional circuitry can easily be included with the photosensors. This is shown in FIG. 2, where transimpedance amplifiers are included on the same substrate. Photodiode 110 is fabricated with grating 130 to be responsive to a particular wavelength of incident light. Amplifier 140 in conjunction with resistors 150 and 160 form a transimpedance amplifier which converts the photocurrent from photodiode 110 into a voltage output 170. A second wavelength is sensed by photodiode 112 coupled with grating 132. Amplifier 142 in conjunction with resistors 152 and 162 form a transimpedance amplifier which converts the photocurrent from photodiode 112 to voltage 172. This embodiment may be fabricated with one or a plurality of wavelength sensors on a single die.

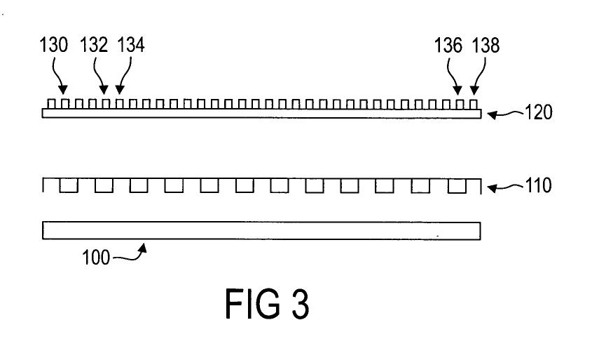

A second embodiment of the invention is shown in FIG. 3. In this embodiment, an N-element photodiode array is coupled with a grating optionally having varying element spacing, providing a sensor which provides a continuous spectral response defined by the spacing of the diffraction grating elements. N-element photodiode sensor array 110 is formed above substrate 100. Layer 120, which passes to the range of wavelengths of interest, supports diffraction grating 130.

In an embodiment in which the spacing of grating elements 130 is uniform, a varying frequency response is obtained in photodiode array 110 due to the operation of grating 130. Spatial distribution of light as a function of wavelength is dependent on the spacing between grating elements. Uniform grating spacing produces a spatial distribution which is logarithmic vs. wavelength.

In an embodiment where grating 130 is nonuniform, the spacing between elements 132, 134, and 136, 138, changes. As an example, if the spacing between elements 132 and 134 is larger than the spacing between elements 136 and 138, grating 130 in the region of elements 132, 134 will pass longer wavelengths than in the region of elements 136, 138. Non-uniform spacing of grating elements adds the ability to engineer the distribution of light vs. wavelength, for example, to produce a linear distribution with respect to wavelength. It should be noted that this embodiment may take the form of a one or two dimensional array depending on the nature of the grating structure.

As with the previous embodiment, an additional metallization or other opaque layer (not shown) can be used to form an aperture of appropriate dimensions to act as a collimating device, shutter or other light regulating mechanism.

Other processing elements may also be integrated onto substrate 100, for example, to process the output of photodiode sensor array 110 or to control the spectral output of the incident light source, thereby forming a closed-loop control system.

The foregoing detailed description of the present invention is provided for the purpose of illustration and is not intended to be exhaustive or to limit the invention to the precise embodiments disclosed. Accordingly the scope of the present invention is defined by the appended claims.

What is claimed is:

1. An improved photosensor for sensing incident light comprising:
a substrate,
one or more photosensors fabricated onto the substrate, and
a diffraction grating fabricated onto the photosensor for coupling incident light of a predetermined wavelength to the photosensor.

2. The improved photosensor of claim 1 further comprising at least one layer between the photosensors and the grating wherein the at least one layer passes incident light in the wavelengths of interest.

3. The improved photosensor of claim 1 where a plurality of photosensors and diffraction gratings responsive to a plurality of wavelengths are fabricated on a single die.

4. The improved photosensor of claim 1 where additional circuit elements are fabricated on the substrate.

5. The improved photosensor of claim 4 where the additional circuit elements include transimpedance amplifiers connected to the photosensors.

6. The improved photosensor of claim 1 where the diffraction grating by photolithographic definition of metal on a dielectric.

7. The improved photosensor of claim 1 where a second metal layer is fabricated as an aperture.

8. The improved photosensor of claim 1 where the aperture is fabricated between the grating and the photosensor.

9. The improved photosensor of claim 7 where the aperture is fabricated between the grating and the incident light.

10. An improved photosensor for sensing incident light comprising:
a substrate,
a photodiode array fabricated onto the substrate, and
a diffraction grating fabricated onto the photosensor for coupling incident light over a range of wavelengths to the photodiode array.

11. The improved photosensor of claim 10 where the grating spacing is uniform

12. The improved photosensor of claim 10 where the grating spacing is nonuniform.

13. The improved photosensor of claim 10 further including additional circuit elements fabricated on the substrate.

14. The improved photosensor of claim 10 where a second metal layer is fabricated as an aperture.

15. The improved photosensor of claim 14 where the aperture is fabricated between the grating and the photodiode array.

16. The improved photosensor of claim 14 where the aperture is fabricated between the grating and the incident light.
